(19) United States
(12) Patent Application Publication
(10) Pub. No.: US 2023/0367933 A1
(43) Pub. Date: Nov. 16, 2023

(54) Internal Hierarchical Polynomial Model for Physics Simulation

(71) Applicant: BWXT Advanced Technologies LLC, Lynchburg, VA (US)

(72) Inventor: Ross PIVOVAR, Lynchburg, VA (US)

(73) Assignee: BWXT Advanced Technologies LLC, Lynchburg, VA (US)

(21) Appl. No.: 18/142,107

(22) Filed: May 2, 2023

Related U.S. Application Data
(60) Provisional application No. 63/341,199, filed on May 12, 2022.

(51) Int. Cl. G06F 30/23

(52) U.S. Cl. CPC G06F 30/23; G06F 2111/10

(57) ABSTRACT

A method is provided for using a hierarchical polynomial model for physics simulation. The method includes obtaining coupled equations for a physics simulation. The coupled equations have variables and boundary conditions that constrain the variables. The method also includes generating meshes corresponding to the coupled equations. The method iteratively solves for the boundary conditions that depend on the variables within the meshes to convergence to improve numerical stability of the physics simulation, including: (i) solving for each variable in a first mesh, while holding the other meshes to a weak convergence, to obtain a first solution; (ii) applying the first solution to resolve a second mesh, to obtain a second solution; and (iii) generating a hierarchical polynomial based on the second solution. The hierarchical polynomial is a functional form of a pre-determined physics equation. The method also (iv) computes new boundary conditions for resolving the meshes, using the hierarchical polynomial.

### RELATED APPLICATION DATA

This application is based on and claims priority under 35 U.S.C. § 119 to U.S. Provisional Application No. 63/341,199, filed May 12, 2022, the entire contents of which are incorporated herein by reference.

### TECHNICAL FIELD

The disclosed implementations relate generally to physics simulation and more specifically to systems and methods for using a hierarchical polynomial model for physics simulation.

### BACKGROUND

Physics simulations typically require user-defined boundary conditions. Root-finding methods can find boundary conditions that are too difficult to find using an analytical method. For multi-physics simulations with coupled physics equations, conventional methods (e.g., Newton's method, bisection method, and secant method) are used after each solution is fully converged. This process can be time consuming, and the time to solution grows with the number of dimensions. Some methods, such as Nelder Mead and iterative conjugate gradients, are time consuming, can take hours to converge, or fail to find a solution within a reasonable amount of time. The root-finding methods require a static or constant topology while searching for a solution. For example, these techniques require static points in a search space, when used for gradient calculations, polynomial (typically quadratic) equations, or other mathematical formulas, for estimating the direction of the target root.

### SUMMARY

Accordingly, there is a need for efficient systems and methods for multi-physics simulations. Techniques described herein can be used for simultaneously solving multiple physics equations that are coupled (e.g., the equations include dependent variables). The techniques use a dynamic topology with conventional root-finding methods. The dynamic topology violates the assumption of the root-finding methods, which prevents root-finding and causes the search for a solution to diverge. To solve this problem, a hierarchical polynomial is used to iteratively correct boundary conditions, while the physics simulation is converging, thereby finding the root more efficiently.

In accordance with some implementations, a method executes at a computing system. Typically, the computing system includes a single computer or workstation, or a plurality of computers, each having one or more CPU and/or GPU processors and memory. The method does not generally require a computing cluster or supercomputer.

In some implementations, a computing system includes one or more computers. Each of the computers includes one or more processors and memory. The memory stores one or more programs that are configured for execution by the one or more processors. The one or more programs include instructions for performing any of the methods described herein.

In some implementations, a non-transitory computer readable storage medium stores one or more programs configured for execution by a computing system having one or more computers, each computer having one or more processors and memory. The one or more programs include instructions for performing any of the methods described herein.

Thus, methods and systems are disclosed that efficiently find solutions for multi-physics equations, using a hierarchical polynomial and conventional root-finding methods. The discussion, examples, principles, compositions, structures, features, arrangements, and processes described herein can apply to, be adapted for, and be embodied in physics simulations.

### BRIEF DESCRIPTION OF THE DRAWINGS

For a better understanding of the disclosed systems and methods, as well as additional systems and methods, reference should be made to the Description of Implementations below, in conjunction with the following drawings in which like reference numerals refer to corresponding parts throughout the figures.

FIG. 1 is a block diagram of a system for physics simulation, in accordance with some implementations.

FIG. 2 is a block diagram illustrating a computing device in accordance with some implementations.

FIG. 3 shows an example bar graph that plots flow rate for different tubes, according to some implementations.

FIG. 4A shows an example graph plot of fluid temperature versus axial distance, FIG. 4B shows an example graph plot of pressure versus axial distance, and FIG. 4C shows an example graph plot of hydraulic static pressure versus axial distance, according to some implementations.

FIG. 5 shows an example 3-D FEM model, according to some implementations.

FIGS. 6A-6J provide a flowchart of an example method for physics simulation, according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

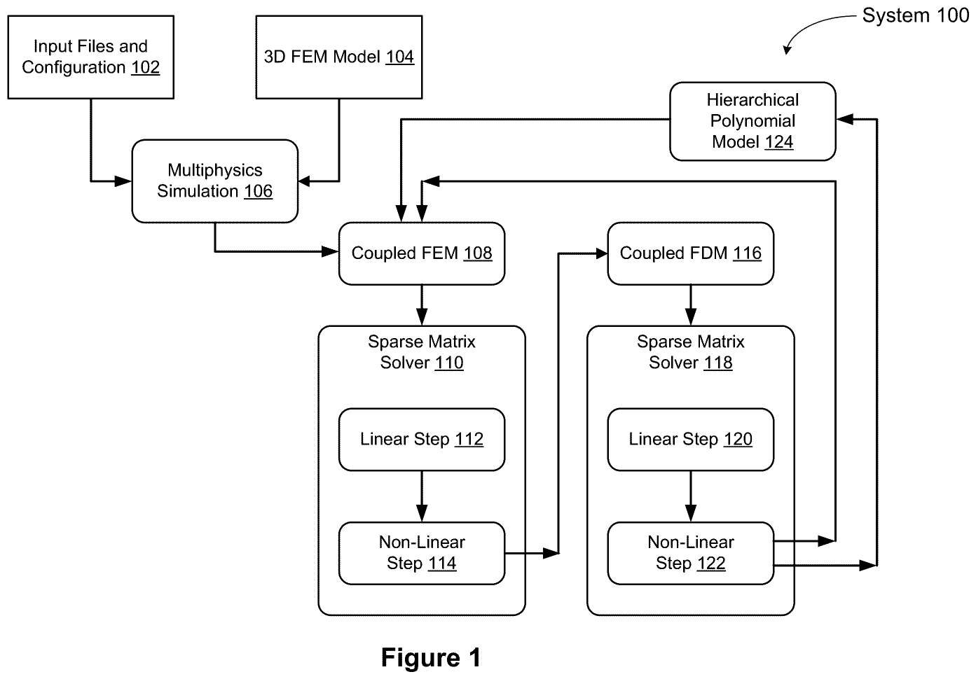

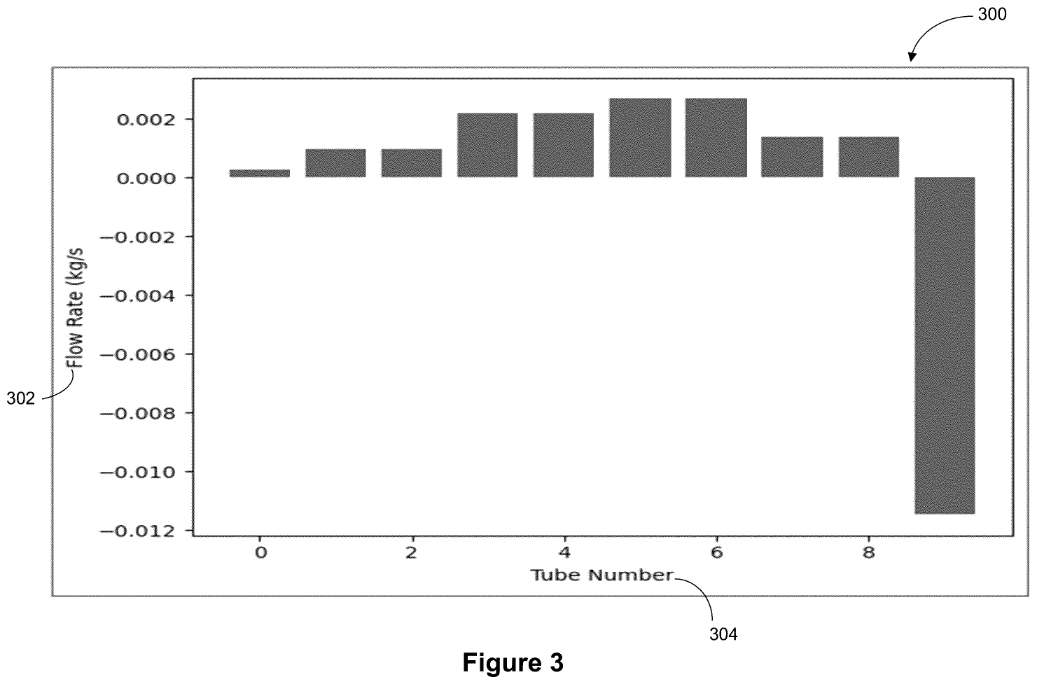

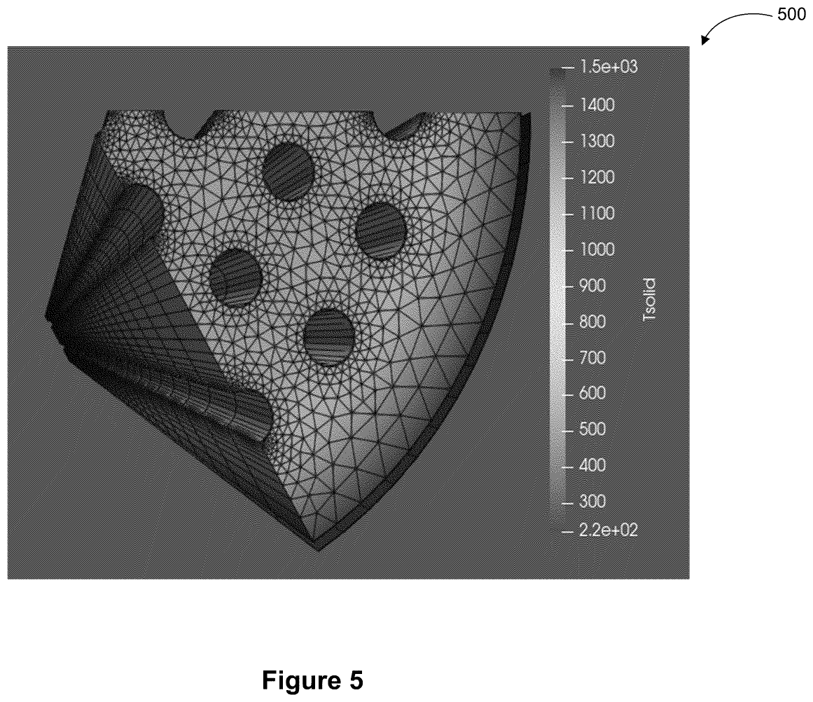

FIG. 1 is a block diagram of a system 100 for physics simulation, in accordance with some implementations. Input files and configuration details 102 (e.g., user input via .csv files or standard input files in ASCII format) are input to a multi-physics simulation module 106. A 3-D Finite-Element Method (FEM) model 104 is also input to the multi-physics simulation module 106. An example 3-D FEM model 500 is shown in FIG. 5, implemented for a fluid-cooled fission reactor, representing the problem of finding the correct flow rate in each channel that achieves isothermal exit conditions, according to some implementations. The multi-physics simulation module 106 may be based on modeling or simulation frameworks, such as MOOSE (Multi-physics Object-Oriented Simulation Environment). An objective of a multi-physics simulation is to find a solution to a coupled set of physics equations (e.g., physics equations for a solid temperature field and a fluid temperature field). In addition, the multi-physics simulation minimizes a physics metric. An example of a physics metric is the determination of flow rates for N fluid channels of a fluid-cooled fission reactor that equalize the pressure drop across all channels in which it is possible that energy can be conducted away from a fluid channel, through a solid, and into another fluid channel. This scenario can be rather difficult to solve and is prone to numerical instabilities. FIG. 3 shows an example bar graph 300 that plots flow rate 302 for different tubes identified by tube numbers 304, according to some implementations. The bar graph shows different flow rates needed to find a solution. Finding the different flow rates is a non-trivial problem. Another example scenario is the objective of finding patterns for flow straightening devices for a flow distribution such that the exit is in an isothermal state. This scenario is also quite difficult and exhibits numerical instabilities.

Referring to FIG. 1, the multi-physics simulation module 106 generates relationship matrices (e.g., Coupled FEM 108 and Coupled Finite-Difference Method (FDM) 116) that relate physics equations to spatial dimensions in the 3-D FEM model 104. For the example scenario described above, for determining flow rates for N fluid channels, the multi-physics simulation module 106 generates two separate meshes: an FEM mesh for the solid material region, and an FDM mesh for the fluid region. Utilizing two separate meshes and iterating to convergence are techniques for improving numerical stability. The matrices (sometimes called meshes) are input to a sparse matrix solver 110. The sparse matrix solver 118 is similar to the sparse matrix solver 110, and may share the same source code, according to some implementations. The sparse matrix solver 110 includes a linear step 112 and a non-linear step 114. Similarly, the sparse matrix solver 118 includes a linear step 120 and a non-linear step 122. Example sparse matrix solvers include Generalized Minimum Residual (GMRES) and Biconjugate Gradient Stabilized Method (BICGSTAB). The output of the sparse matrix solver 110 is input to the Coupled FDM 116, which is in turn input to the sparse matrix solver 118. The sparse matrix solver 110 solves coupled FEM equations (as specified by the Coupled FEM 108), and the sparse matrix solver 118 solves coupled FDM equations (as specified by the Coupled FDM 116). In root-finding solvers, output of the sparse matrix solver 118 (in particular, output from the non-linear step 122) is input back to the Coupled FEM 108, which is solved by the sparse matrix solver 110. The process is repeated, or iterated, using an iterator, such as Picard iterations. According to the techniques described herein, the initial FEM mesh is resolved independently of the FDM mesh, which is held to weak convergence criteria. The FDM mesh then applies pertinent information from the FEM solution to the FDM mesh and resolves a step in the FDM physics field. Unlike conventional systems, the system 100 described herein also inputs the output from the non-linear step 122 to a hierarchical polynomial model 124, which generates new boundary conditions for the next iteration of the solvers 110 and 118. In some implementations, the hierarchical polynomial model 124 intercepts a linear algebra solution from the sparse matrix solver 118 and biases the solution to find the roots of the multi-physics equations. Before starting a next iteration in the FEM/FDM solution, the hierarchical polynomial is used to provide a new guess to the boundary conditions, for resolving the physics metric, such as altering the flow to equalize pressure. In other words, not only is the temperature for fluids and solids being resolved, but the entire problem state is altered by changing the boundary conditions that the original solution was attempting to resolve.

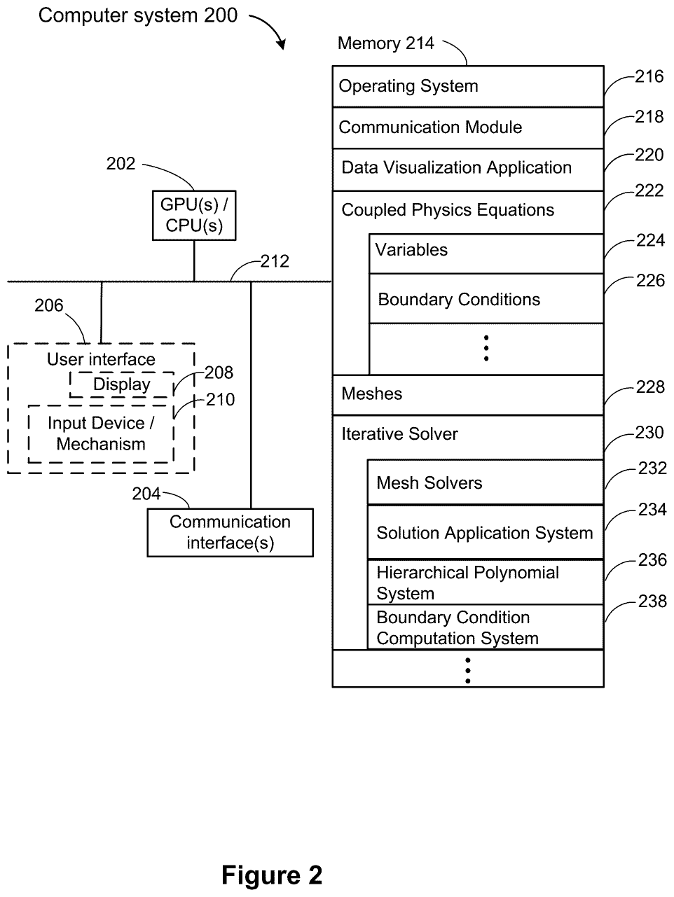

FIG. 2 is a block diagram illustrating a computing device 200 in accordance with some implementations. Various examples of the computing device 200 include high-performance clusters (HPC) of servers, supercomputers, desktop computers, cloud servers, and other computing devices. The computing device 200 typically includes one or more processing units/cores (CPUs and/or GPUs) 202 for executing modules, programs, and/or instructions stored in the memory 214 and thereby performing processing operations; one or more network or other communication interfaces 204; memory 214; and one or more communication buses 212 for interconnecting these components. The communication buses 212 may include circuitry that interconnects and controls communications between system components.

The computing device 200 may include a user interface 206 comprising a display device 208 and one or more input devices or mechanisms 210. In some implementations, the input device/mechanism includes a keyboard. In some implementations, the input device/mechanism includes a “soft” keyboard, which is displayed as needed on the display device 208, enabling a user to “press keys” that appear on the display 208. In some implementations, the display 208 and input device/mechanism 210 comprise a touch screen display (also called a touch sensitive display).

In some implementations, the memory 214 includes high-speed random access memory, such as DRAM, SRAM, DDR RAM or other random access solid state memory devices. In some implementations, the memory 214 includes non-volatile memory, such as one or more magnetic disk storage devices, optical disk storage devices, flash memory devices, or other non-volatile solid state storage devices. In some implementations, the memory 214 includes one or more storage devices remotely located from the GPU(s)/CPU(s) 202. The memory 214, or alternatively the non-volatile memory device(s) within the memory 214, comprises a non-transitory computer readable storage medium. In some implementations, the memory 214, or the computer-readable storage medium of the memory 214, stores the following programs, modules, and data structures, or a subset thereof:
an operating system 216, which includes procedures for handling various basic system services and for performing hardware dependent tasks;
a communication module 218, which is used for connecting the computing device 200 to other computers and devices via the one or more communication network interfaces 204 (wired or wireless) and one or more communication networks, such as the Internet, other wide area networks, local area networks, metropolitan area networks, and so on;
an optional data visualization application or module 220 for displaying visualizations of physics simulation;
coupled physics equations 222, which include variables 224 and boundary conditions 226;
meshes 228 (e.g., an FDM mesh and/or an FEM mesh); and
an iterative solver 230, which includes mesh solvers 232 (e.g., an FEM mesh solver and an FDM mesh solver), a solution application system 234, which applies pertinent solutions (e.g., solutions for shared or dependent variables) from a solution for a first set of equations to a second set of equations, a hierarchical polynomial system 236, and a boundary condition computation system 238.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 214 stores a subset of the modules and data structures identified above. Furthermore, the memory 214 may store additional modules or data structures not described above. The operations of each of the modules and properties of the data structures shown in FIG. 2 are further described below, according to some implementations.

Although FIG. 2 shows a computing device 200, FIG. 2 is intended more as a functional description of the various features that may be present rather than as a structural schematic of the implementations described herein. In practice, and as recognized by those of ordinary skill in the art, items shown separately could be combined and some items could be separated.

FIG. 3 shows an example bar graph that plots flow rate for different tubes, according to some implementations. FIG. 3 illustrates that unique flow rates were determined for each tube that achieves the exit conditions.

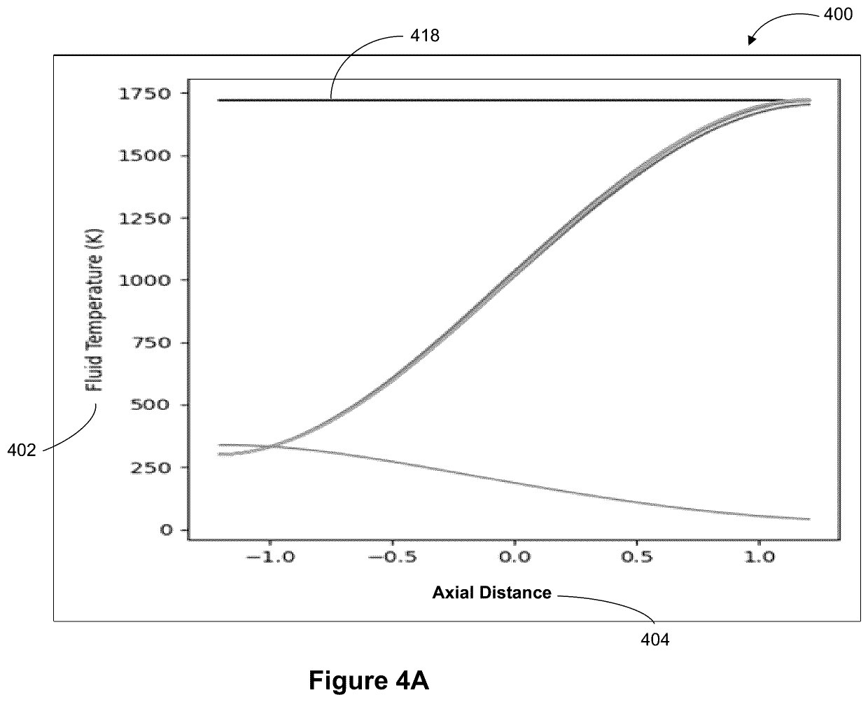

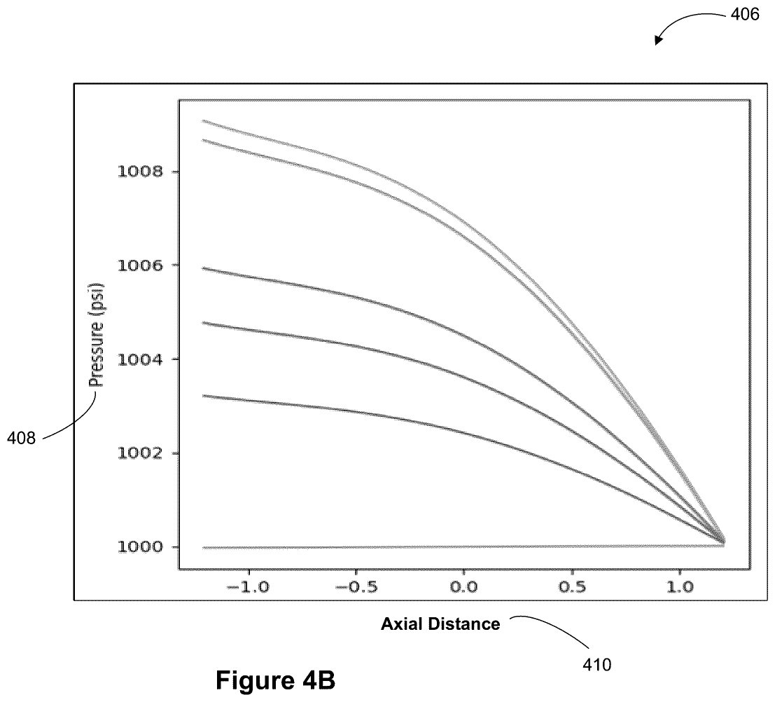

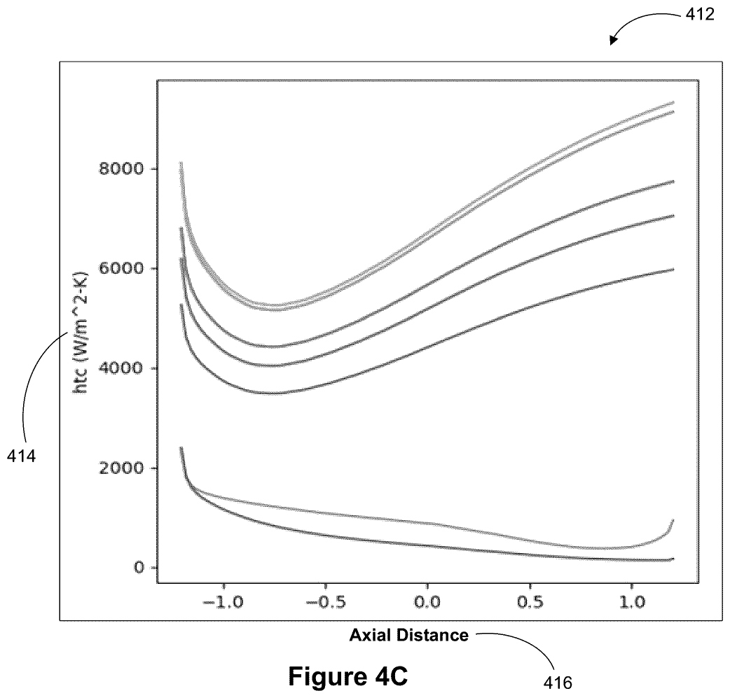

FIG. 4A shows an example graph plot 400 of fluid temperature 402 versus axial distance 404, FIG. 4B shows an example graph plot 406 of pressure 408 versus axial distance 410, and FIG. 4C shows an example graph plot 412 of hydrothermal carbonization 414 versus axial distance 416. These graph plots correspond to the running example described above in reference to FIGS. 1 and 3, for flow rate determination, where the techniques described herein are used for physics simulation, according to some implementations. Each curve in FIG. 4A, FIG. 4B, and FIG. 4C corresponds to a solution for a different tube. The graph plots demonstrate that changes to the flow rates achieved an isothermal exit. For example, in FIG. 4A, an inlet temperature is given, and due to the power distribution and geometry, each hole will naturally result in a different amount of power and thus a different exit temperature. FIG. 4A demonstrates that the techniques described herein determined appropriate flow inlet flow rates that result in the correct target exit temperature (line 418 is the target temperature). FIG. 4A shows that an isothermal exit condition was met as claimed.

FIG. 5 shows an example 3-D FEM model, according to some implementations. FIGS. 3, 4A, 4B, and 4C are the results of a simulation. FIG. 5 shows the component for the physics simulation. In particular, FIG. 5 shows the geometry of the simulated component.

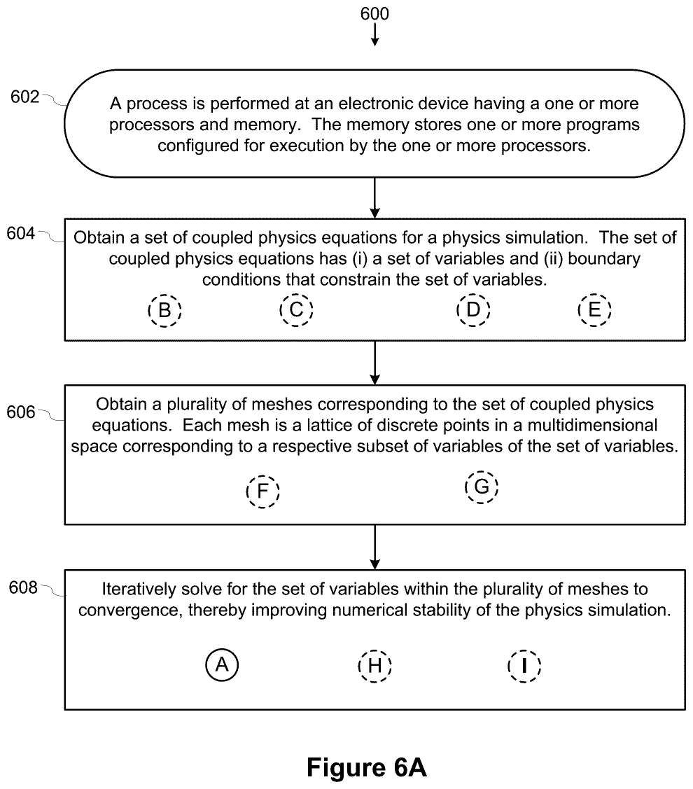

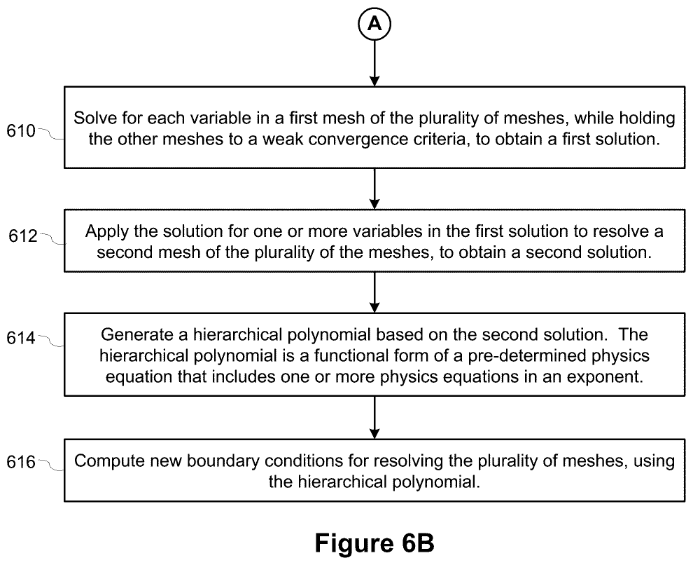

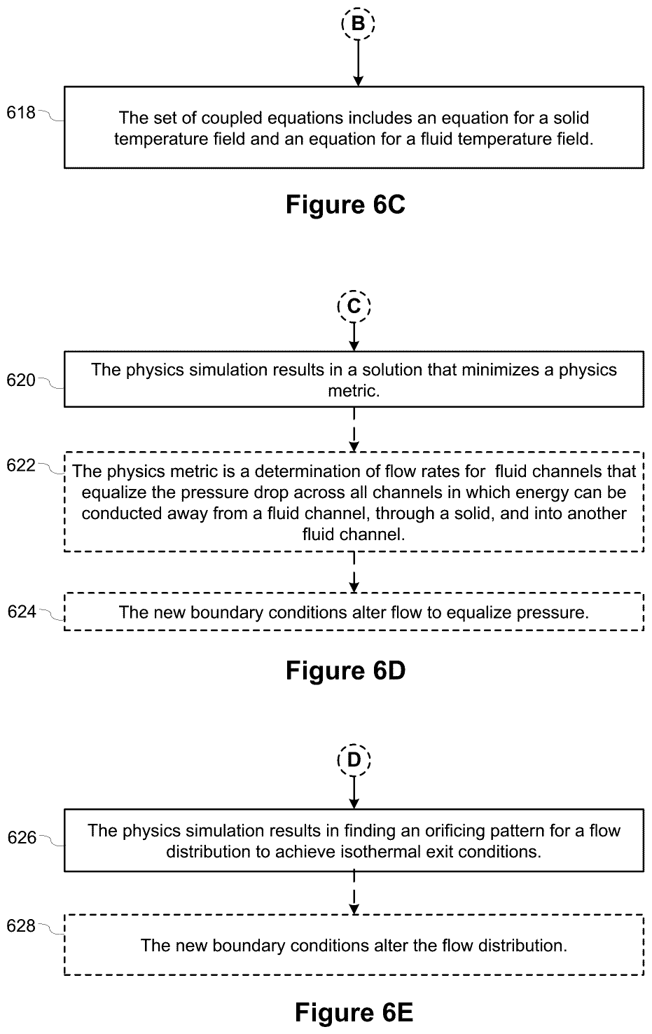

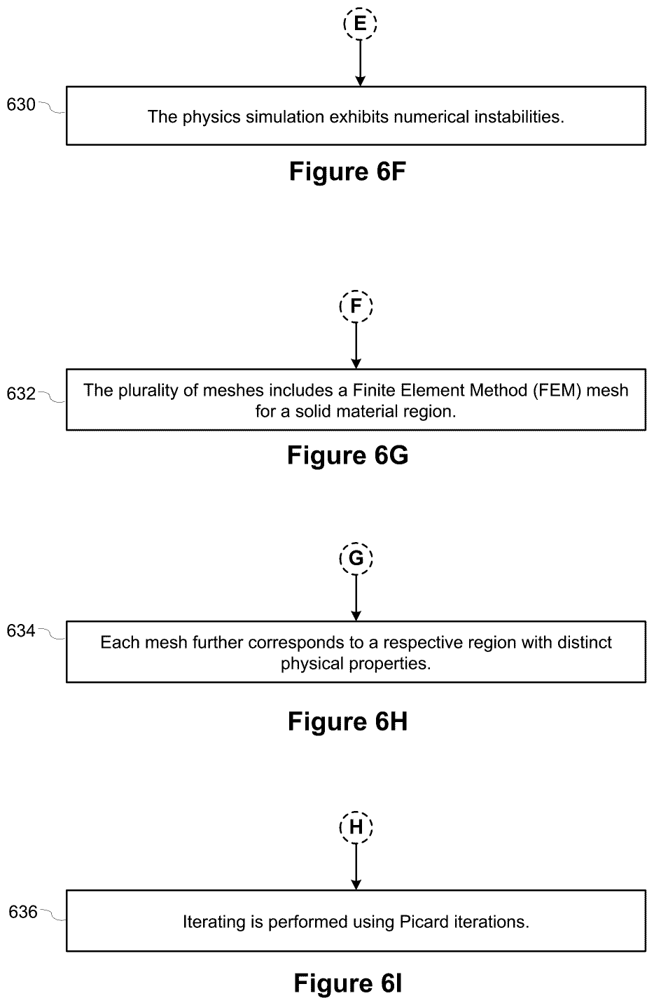

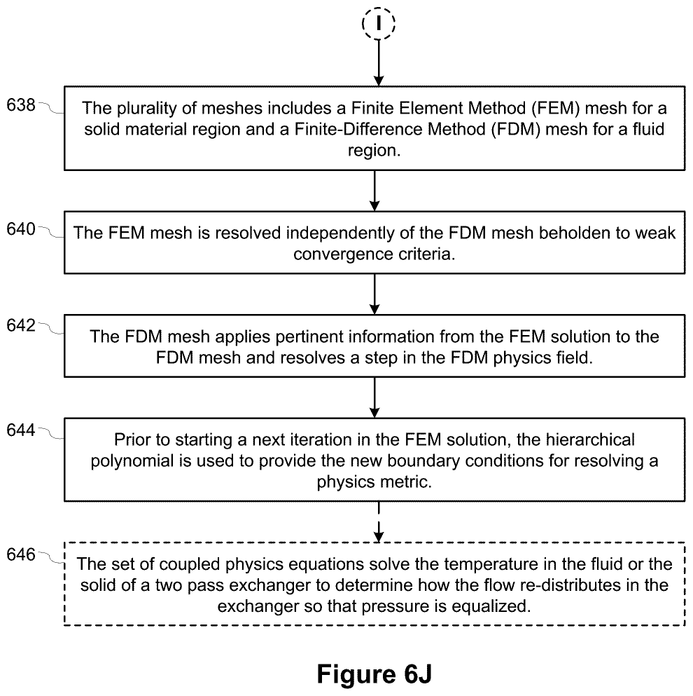

FIGS. 6A-6J provide a flowchart of an example method 600 of physics simulation, according to some implementations. The method is performed (602) at an electronic device having one or more processors, and memory storing one or more programs configured for execution by the one or more processors. The method includes obtaining (604) a set of coupled physics equations for a physics simulation. The set of coupled physics equations has (i) a set of variables and (ii) boundary conditions that constrain the set of variables. Some implementations define boundary constraints to create a matrix of a “perfectly constrained” system of equations. Example variables include inlet mass flow rate, initial temperature of a solid, and pressure. The equations are usually differential equations, which are functions of the variables. Solving systems of partial differential equations requires complex methods, because the variables are functions of each other. For example, if pressure goes up, temperature increases. If temperature decreases, pressure decreases. The system is extremely interdependent. The boundary conditions are used to determine which variables are driving other variables, to obtain a finite solution.

The method also includes obtaining (606) a plurality of meshes corresponding to the set of coupled physics equations. Each mesh is a lattice of discrete points in a multidimensional space corresponding to a respective subset of variables of the set of variables. Typically, the vertices of a mesh map the spatial coordinates (e.g., x, y, z coordinates) and the connection of each coordinate to other coordinates in space. An equation is then assigned to a specific point in space where this equation describes the relationship of physics variables to other variables. The mesh sets up the relationship of spatial points to other spatial points. Then the system reads in the mesh and assigns physics equations to the mesh, according to some implementations. In some instances, this step includes determining which partial differential equation is applied to each node in the mesh. For example, this can include determining what the specific temperature (as computed by a corresponding partial differential equation) is at a given node. For this example, for a given set of boundary conditions, the solution is the set of temperatures for every node that balance the partial differential equations and achieves the user defined boundary conditions. To illustrate further, suppose a solid material energy equation follows an equation for thermal diffusion. Further suppose that the exterior of the solid has a temperature of 330 K. The system can determine temperatures in the solid that follows the constraint of 330 K. Some implementations assign one or more equations at a specific point in space. To illustrate, suppose there are two points A and B, and the set of physics equations include Q_{L}=0.15*(T_{A}−T_{B}), Q_{R}=0.25*(T_{B}−T_{A}), and Q_{W}=0.25*(T_{B}−300). T_{A} and T_{B} are temperatures at those two points and Q is the energy. Suppose these two points are for a material that touch each other. Then conduction occurs and thus Q_{L}=Q_{R}=Q_{W}. Note that this system of equations is easily solved for the two temperatures. However, an FEM model can typically include millions of points and is not easily solved using conventional methods. In some implementations, the system receives, from a user, the mesh of geometric locations in space. The system then assigns equations to the points in space.

The method also includes iteratively solving (608) for the set of boundary conditions that constrain the set of variables within the plurality of meshes to convergence. This technique improves numerical stability of the physics simulation where boundary conditions implicitly depend on variables within the meshes. In contrast, with a conventional gradient-based method like the secant method, the search diverges or oscillates, and fails to determine a solution to the boundary conditions. Thus, with conventional solutions, the physics simulation is numerically unstable, and does not converge to a single value.

Referring next to FIG. 6B, the device solves (610) for each variable in a first mesh of the plurality of meshes, while holding the other meshes to weak convergence criteria (e.g., loose convergence criteria such that the solution is not completely converged), to obtain a first solution. The device also applies (612) the solution for one or more variables in the first solution to resolve a second mesh of the plurality of the meshes, to obtain a second solution. The one or more variables are chosen depending on the physics simulation. For example, for pressure equalization search using this method, the system iteratively finds the mass flow rate boundary constraint. For this example, FEM resolves the temperature field of solid, and FDM takes pertinent information, which is the surface temperatures in contact with the fluid domain. The device also generates (614) a hierarchical polynomial based on the second solution. The hierarchical polynomial is a functional form of a pre-determined physics equation that includes one or more physics equations in an exponent (similar to either Bayesian regression methods, or a simplified non-linear neural network). The coefficients of the hierarchical polynomial are unique to the physics it is being applied to. The coefficients are typically called “hyper-parameters” or “tuning knobs.” The coefficients depend on the application and a user may typically try default values and adjust the values to ensure convergence occurs.

The exponent of the hierarchical polynomial may depend on the second solution. To illustrate, suppose the system is solving physics equations to get the temperature of a fluid in a tube. The hierarchical polynomial (sometimes called a hierarchical model) is used to determine an inlet flow rate that results in a target exit temperature as follows. After the second solution obtains the temperatures, the system obtains an exit temperature and inputs it to the hierarchical model, which in turn produces the inlet flow rate for the next iteration, and the process is repeated with the inlet flow rate.

The device also computes (616) new boundary conditions for resolving the plurality of meshes, using the hierarchical polynomial. In the example described above, fluid domain resolution uses the hierarchical polynomial to determine a new boundary constraint. Stated differently, the hierarchical polynomial is an equation that is setup for a specific set of physics equations. Suppose the objective of a physics simulation is to equalize pressure drop. The pressure drop is an input and the equation output is flow rate. Flow rate is a boundary condition. Subsequently, the system repeats finding the FEM solution with updated constraints, until convergence. In this way, the technique turns the boundary constraint into a variable, which causes an under-constrained system of equations, which typically means an infinite set of solutions. But by optimally solving the set of equations, by iteratively reweighting the boundary constraint, the system obtains a series of “perfectly constrained” problems until the system converges on a solution. A common statistical technique for determining optimal solutions is to iteratively update important variables. When setting up the hierarchical polynomial, the important variables are derived from physics. The variables that are left in the final end result physics equation dictate the importance. The important variables are the physics variables relevant for boundary condition determination. For example, suppose there are three channels. A first iteration might use the multipliers 1.0, 1.0, and 1.0 on flow rate, a second iteration might use the multipliers 0.5, 1.2, and 0.5 on the flow rate, and a third iteration might use the multipliers 0.49, 1.21, and 0.51 on the flow rate, and this process is repeated until convergence.

Referring next to FIG. 6C, in some implementations, the set of coupled equations includes (618) an equation for a solid temperature field and an equation for a fluid temperature field.

Referring next to FIG. 6D, in some implementations, an objective of the physics simulation is minimizing (620) a physics metric. In some implementations, the physics metric is a determination (622) of flow rates for N fluids channels that equalize the pressure drop across all channels in which energy can be conducted away from a fluid channel, through a solid, and into another fluid channel. In some implementations, the new boundary conditions alter (624) the flow to equalize pressure.

Referring next to FIG. 6E, in some implementations, an objective of the physics simulation is finding (626) a pattern for flow straightening devices for a flow distribution to achieve isothermal exit conditions. In some implementations, the new boundary conditions alter (628) the flow distribution.

Referring next to FIG. 6F, in some implementations, the physics simulation exhibits (630) numerical instabilities.

Referring next to FIG. 6G, in some implementations, the plurality of meshes includes (632) a Finite Element Method (FEM) mesh for a solid material region. In some implementations, the plurality of meshes includes a Finite-Difference Method (FDM) mesh for a fluid region.

Referring next to FIG. 6H, in some implementations, each mesh further corresponds (634) to a respective region with distinct physical properties.

Referring next to FIG. 6I, in some implementations, iterating is performed using (636) Picard iterations.

Referring next to FIG. 6J, in some implementations, the plurality of meshes includes (638) a Finite Element Method (FEM) mesh for a solid material region and a Finite-Difference Method (FDM) mesh for a fluid region. The FEM mesh is resolved (640) independently of the FDM mesh while holding to weak convergence criteria. The FDM mesh applies (642) pertinent information from the FEM solution to the FDM mesh and resolves a step in the FDM physics field. Prior to starting a next iteration in the FEM solution, the hierarchical polynomial is used (644) to provide the new boundary conditions for resolving a physics metric. In some implementations, the set of coupled physics equations solve (646) the temperature in the fluid or the solid of a two-pass exchanger to determine how the flow re-distributes in the exchanger so that pressure is equalized. In some implementations, the solution for the FEM mesh is defined by the equation

$$\frac{\partial T}{\partial t} = α \cdot {∇}^{2} T ,$$

where T is temperature, and t is time. In some implementations, the solution for the FDM mesh is defined by the equations:

$$\begin{matrix}\frac{1}{{A}_{f}} Δ \dot{m} \frac{Δ z}{Δ t} - \frac{{\dot{m}}^{2}}{{ρ}^{2} \cdot {A}_{f}^{2}} Δ ρ = - Δ P + \frac{f Δ z}{2 \cdot {D}_{h}} \frac{{\dot{m}}^{2}}{ρ {A}_{f}^{2}} \\ {A}_{f} ρ {c}_{p} \frac{Δ z}{Δ t} Δ T + {c}_{p} \dot{m} Δ T = Q\end{matrix}$$

where \dot{m} is a mass flow rate boundary condition.

In some implementations, FDM results are used to compute the hierarchical polynomial by performing the following equation on each fluid channel:

$${\dot{m}}^{i + 1} = {\dot{m}}^{i} \cdot sgn ( {P}^{T} - {P}^{i} ) {( \vert \frac{{P}^{i}}{{P}^{T}} - 1 \vert )}^{{C}_{0} \cdot {\dot{m}}^{i}}$$

where P^{T}=P̅, i is the current iteration value, i+1 is the next iteration value, P^{T} is the target pressure drop, P̅ is the average pressure drop of all channels, and sgn is a function that computes the sign of its input. The sgn( ) function is commonly pronounced “signum” so that it is not confused with the “sine” function. The sgn( ) function is defined by sgn(x)=−1 when x<0, sgn(0)=0, and sgn(x)=1 when x>0.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method of physics simulation, the method comprising:
obtaining a set of coupled physics equations for a physics simulation, wherein the set of coupled physics equations has (i) a set of variables and (ii) boundary conditions that constrain the set of variables;
obtaining a plurality of meshes corresponding to the set of coupled physics equations, wherein each mesh is a lattice of discrete points in a multidimensional space corresponding to a respective subset of variables of the set of variables; and
iteratively solving for the boundary conditions that implicitly depend on the set of variables within the plurality of meshes to convergence to improve numerical stability of the physics simulation, including:
solving for each variable in a first mesh of the plurality of meshes, while holding the other meshes to weak convergence criteria, to obtain a first solution;
applying a solution for one or more variables in the first solution to resolve a second mesh of the plurality of the meshes, to obtain a second solution;
generating a hierarchical polynomial based on the second solution, wherein the hierarchical polynomial (i) is a functional form of a pre-determined physics equation and (ii) includes one or more physics equations in an exponent; and
computing new boundary conditions for resolving the plurality of meshes, using the hierarchical polynomial.

2. The method of claim 1, wherein the set of coupled equations includes an equation for a solid temperature field and an equation for a fluid temperature field.

3. The method of claim 1, wherein the physics simulation minimizes a physics metric.

4. The method of claim 3, wherein the physics metric is a determination of flow rates for N fluid channels that equalize the pressure drop across all channels in which energy can be conducted away from a fluid channel, through a solid, and into another fluid channel.

5. The method of claim 4, wherein the new boundary conditions alter the flow rates for the N fluid channels to equalize pressure

6. The method of claim 1, wherein the physics simulation finds a pattern for a flow straightening device for a flow distribution to achieve isothermal exit conditions.

7. The method of claim 6, wherein the new boundary conditions alter the flow distribution.

8. The method of claim 1, wherein the physics simulation exhibits numerical instabilities.

9. The method of claim 1, wherein the plurality of meshes includes a Finite Element Method (FEM) mesh for a solid material region.

10. The method of claim 1, wherein the plurality of meshes includes a Finite-Difference Method (FDM) mesh for a fluid region.

11. The method of claim 1, wherein each mesh further corresponds to a respective region with distinct physical properties.

12. The method of claim 1, wherein iterating is performed using Picard iterations.

13. The method of claim 1, wherein:
the plurality of meshes includes a Finite Element Method (FEM) mesh for a solid material region and a Finite-Difference Method (FDM) mesh for a fluid region;
the FEM mesh is resolved independently of the FDM mesh that is held to weak convergence criteria;
the FDM mesh applies pertinent information from the FEM solution to the FDM mesh and resolves a step in the FDM physics field; and
prior to starting a next iteration in the FEM solution, the hierarchical polynomial is used to provide the new boundary conditions for resolving a physics metric.

14. The method of claim 13, wherein the set of coupled physics equations solve for temperature in a fluid and a solid of a two-pass exchanger to determine how the flow re-distributes in the exchanger so that pressure is equalized.

15. The method of claim 14, wherein:
a solution for the FEM mesh is defined by the equation:
$$\frac{\partial T}{\partial t} = a \cdot {∇}^{2} T$$
wherein T is temperature, t is time, and a is a constant.

16. The method of claim 15, wherein a solution for the FDM mesh is defined by the equations:
$$\begin{matrix}\frac{1}{{A}_{f}} Δ \dot{m} \frac{Δ z}{Δ t} - \frac{{\dot{m}}^{2}}{{ρ}^{2} \cdot {A}_{f}^{2}} Δ ρ = - Δ P + \frac{f Δ z}{2 \cdot {D}_{h}} \frac{{\dot{m}}^{2}}{ρ {A}_{f}^{2}} \\ {A}_{f} ρ {c}_{p} \frac{Δ z}{Δ t} Δ T + {c}_{p} \dot{m} Δ T = Q\end{matrix}$$
wherein \dot{m} is a mass flow rate boundary condition.

17. The method of claim 16, wherein FDM results are used to compute the hierarchical polynomial by applying the following equation on each fluid channel:
$${\dot{m}}^{i + 1} = {\dot{m}}^{i} \cdot sgn ( {P}^{T} - {P}^{i} ) {( \vert \frac{{P}^{i}}{{P}^{T}} - 1 \vert )}^{{C}_{0} \cdot {\dot{m}}^{i}}$$
wherein P^{T}=P̅, i is a current iteration value, i+1 is a next iteration value, P^{T} is a target pressure drop, P̅ is average pressure drop of all channels, and sgn is the numerical sign.

18. A computer system for physics simulation, comprising:
one or more processors; and
memory;
wherein the memory stores one or more programs configured for execution by the one or more processors, and the one or more programs comprise instructions for performing the method of claim 1.

19. A computer system for physics simulation, comprising:
one or more processors; and
memory;
wherein the memory stores one or more programs configured for execution by the one or more processors, and the one or more programs comprise instructions for performing the method of claim 17.

20. A non-transitory computer readable storage medium storing one or more programs configured for execution by a computer system having one or more processors and memory, the one or more programs comprising instructions for performing the method of claim 1.

21. A non-transitory computer readable storage medium storing one or more programs configured for execution by a computer system having one or more processors and memory, the one or more programs comprising instructions for performing the method of claim 17.
